(19) United States
(12) Patent Application Publication
(10) Pub. No.: US 2015/0137505 A1
(43) Pub. Date: May 21, 2015

(54) Header Tethering System

(71) Applicant: Lokar, Inc., Knoxville, TN (US)

(72) Inventors: Kevin Ford, Knoxville, TN (US); Scott Thiel, Sherwood, OR (US)

(21) Appl. No.: 14/548,362

(22) Filed: Nov. 20, 2014

Related U.S. Application Data
(60) Provisional application No. 61/907,255, filed on Nov. 21, 2013.

(51) Int. Cl. F16L 41/03; F01N 13/18

(52) U.S. Cl. CPC F16L 41/03; F01N 13/1805; F01N 13/1838
USPC 285/81

(57) ABSTRACT

A header tethering device that provides retention of a header to a collector to prevent separation of the header from the collector is disclosed. A header clamp has a first band configured to encircle the header and establish a frictional connection therewith. A collector clamp has a second band configured to encircle the collector and establish a frictional connection therewith. A flexible tether has a first end mounted to the header clamp and an opposite second end mounted to the collector clamp. When the header clamp is secured to the header and the collector clamp is secured to the collector with the tether extended therebetween, the tether prevents separation of the header from the collector.

### CROSS-REFERENCE TO RELATED APPLICATIONS

This application claims the benefit of U.S. Provisional Patent Application Ser. No. 61/907,255, filed on Nov. 21, 2013, which is incorporated herein in its entirety by reference.

### STATEMENT REGARDING FEDERALLY-SPONSORED RESEARCH OR DEVELOPMENT

Not Applicable

### BACKGROUND OF THE INVENTION

1. Field of Invention

The present general inventive concept relates to a header tethering device for an exhaust system for a combustion engine, and in particular an exhaust system of a vehicle, that allows for a secondary retention system to prevent the collectors of the exhaust system from disconnecting from the headers during operation of the engine.

2. Description of the Related Art

Exhaust manifolds for collecting the exhaust gasses from multiple cylinders of a combustion engine and directing the collected gasses into a single exhaust pipe are known in the art. In many engine designs, a tubular exhaust manifold, known as a “header,” is provided for each cylinder. Multiple headers typically converge into a single tube called a “collector,” which leads to an exhaust pipe of the engine.

In several motor vehicle designs, the various headers are connected to the collector via a joint or other connection system. Example connection systems typical in the art include bolted connections and/or spring load interfaces. For example, in many motor vehicle designs, each header is connected to the collector via a bolt which is received through two tabs, one tab on the header tube and one on the collector. This bolt and tab assembly can sometimes fail due to fatigue, excessive heat, vibration, wear, etc. In such an event, the collector can disconnect from the header tube, which may in certain circumstances result in the collector falling free from the vehicle. If this occurs while the vehicle is in movement, a potential hazard results. Danger created by a collector disconnecting from the headers of a motor vehicle is especially prominent in racing situations due to the speed of a racing motor vehicle in operation. Thus, there is a need for a device that provides a secondary retention feature, in addition to the available primary retention system, that limits the collector of a motor vehicle exhaust manifold from separating from the motor vehicle if the primary retention system fails.

### BRIEF SUMMARY OF THE INVENTION

Described herein is a retention device which may be used with a multi-piece header system in a motor vehicle, and more particularly, in a race vehicle. In some of its many embodiments, the present general inventive concept provides a header tethering system that serves as a retaining device to ensure the attached collectors will remain attached. The tethering system may, in several embodiments, work with most or all multi-piece header assemblies and is adaptable to fit a variety of tubes, thereby allowing racers to freely and easily change collectors at any time.

In several embodiments, the header tethering system includes at least two clamps and a tether. The two clamps include at least one header clamp for attachment to a header, and one collector clamp for the attachment to a collector. The diameter of the clamps for the header and the collector may vary and may also contain a grip feature.

Additional aspects and advantages of the present general inventive concept will be set forth in part in the description which follows, and, in part, will be obvious from the description, or may be learned by practice of the present general inventive concept.

### BRIEF DESCRIPTION OF THE SEVERAL VIEWS OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a perspective view showing one embodiment of a header tethering system constructed in accordance with several aspects of the present general inventive concept;

FIG. 2 is a perspective view showing the header tethering system of FIG. 1 installed on a header and collector assembly;

FIG. 3 is a perspective view showing another embodiment of a header tethering system constructed in accordance with several aspects of the present general inventive concept, with the header tethering system installed on a header and collector assembly;

FIG. 4 is a perspective view showing the header clamp portion of the header tethering system of FIG. 3; and

FIG. 5 is a perspective view showing the collector clamp portion of the header tethering system of FIG. 3.

### DETAILED DESCRIPTION OF THE INVENTION

Reference will now be made to the example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

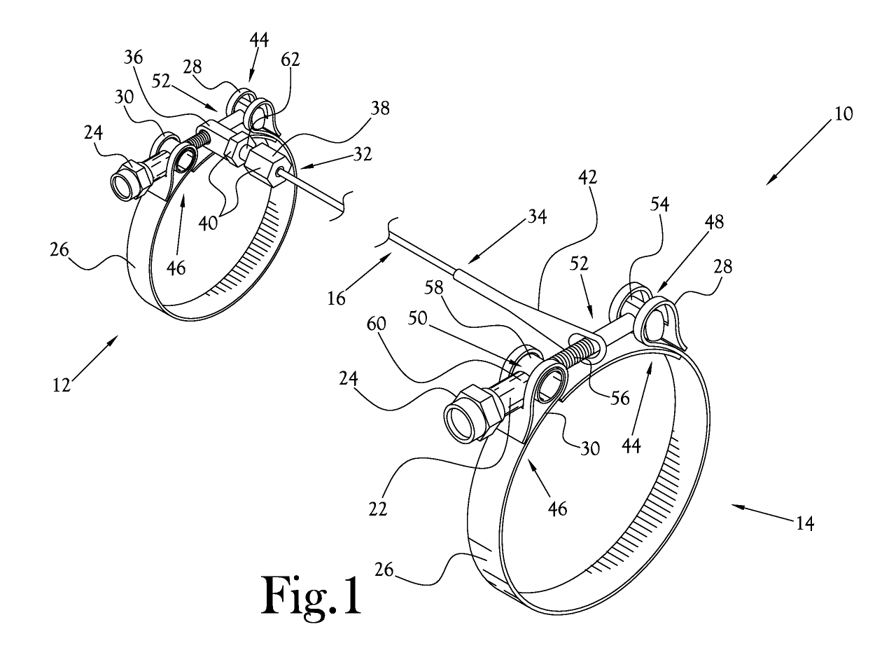

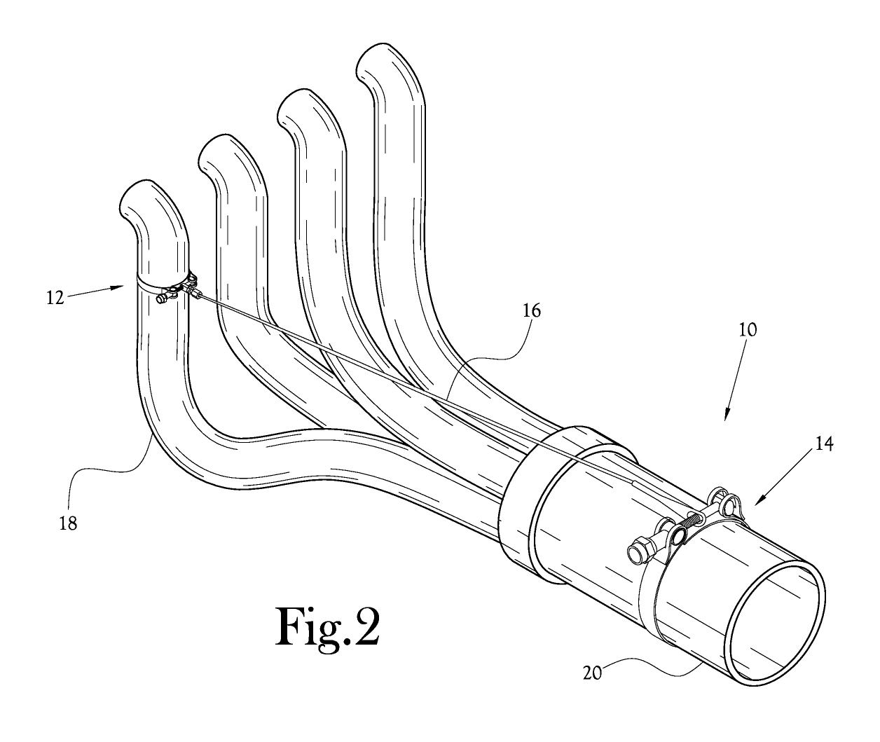

According to various examples of the present general inventive concept, a header tethering system is provided which allows a secondary retention feature for a header assembly in the event the primary connection system fails. One embodiment of a header tethering system constructed in accordance with several features of the present general inventive concept is illustrated at 10 in FIGS. 1 and 2. With reference to FIGS. 1 and 2, the header tethering system 10 comprises at least two clamps, namely, a header clamp 12 and a collector clamp 14, which are adapted to establish a secure connection between a header 18 of a combustion engine exhaust manifold and a collector 20 of an exhaust system for the combustion engine. The header clamp 12 and collector clamp 14 are connected via a tether 16 which is configured to limit separation of the clamps 12, 14 beyond full extension of the tether 16. Thus, when the clamps 12, 14 are secured to a header 18 of a combustion engine exhaust manifold and a collector 20 of an exhaust system, the tether 16 limits separation of the collector 20 from the header 18.

In the illustrated embodiment, each of the clamps 12, 14 of the header tether system 10 is adapted to encircle a respective header 18 or collector 20 in snug conformity thereto, so as to establish a frictional connection therewith. More specifically, in the illustrated embodiment, each of the clamps 12, 14 includes a flat band 26 having opposite first and second ends 44, 46, respectively. Each band 26 is provided in a generally circular arrangement such that the band 26 may encircle and frictionally engage an outer circumference of a respective header 18 or collector tube 20. In several embodiments, each circular band 26 is sufficiently flexible to allow the band to conform to any of a variety of sizes and shapes of collectors, such that the clamp 12, 14 may be adjusted to fit any of a variety of headers 18 or collectors 20 having various diameters and cross-sectional shapes. Each band 26 may be constructed of various materials, such as for example, metal, polymer, or other materials that can provide sufficient support and flexibility. It will be recognized that numerous other materials may be used to construct the bands 26 without departing from the spirit and scope of the present general inventive concept.

Each clamp 12, 14 further includes a fastener assembly which is adapted to urge the first and second ends 44, 46 of the respective band 26 toward one another, thereby securing the band 26 in frictional engagement with the header 18 or collector 20. In the embodiment illustrated in FIG. 1, each of the opposite first and second ends 44, 46 of each band 26 forms a loop 28, 30 having an axial dimension extending generally parallel to an axial dimension of the circular band 26. Each of the loops 28, 30 further defines a cutout 48, 50 extending along a circumference of the loop at a central location along the axial dimension of the loop. A bolt 52 is provided having a T-shaped head portion 54 which is received within and along a first of the loops 28, such that an externally-threaded shaft portion 56 of the bolt 52 extends outwardly through the cutout 48 of the first loop 28 and along a circumference of the band 26. A tubular insert 58 is received coaxially along the second loop 30. The tubular insert 58 is of a slightly greater diameter than the shaft portion 56 of the bolt 52 and defines a through opening 60 extending generally perpendicularly to the axial dimension of the second loop 30. The shaft portion 56 of the bolt 52 is slidably received through the second cutout 50 and the through opening 60 of the insert 58, and an internally-threaded nut 24 is threadably received onto the externally-threaded end of the shaft portion 56, thereby securing the shaft portion 56 of the bolt 52 slidably within the through opening 60. In the illustrated embodiment, a tubular spacer 22 is provided between the nut 24 and the insert 58, thereby positioning the nut 24 outwardly from the insert 58 and the associated second loop 28b of the band 26.

In the above-discussed configuration, the nut 24 of each clamp 12, 14 may be threated further onto the shaft portion 56 of its respective bolt 52 in order to draw the first and second loops 28, 30 of the band 26 toward one another. Thus the overall diameter of the band 26 is decreased, and the band 26 may be tightened onto the header 18 or collector 20. Conversely, the nut 24 may be threadably retreated along the shaft portion 56 of the bolt 52 in order to allow the first and second loops 28, 30 to separate from one another, thereby increasing the overall diameter of the band 26 and loosening the band 26 from the header 18 or collector 20. Thus, the band 26 may be selectively tightened and loosened by selectively threading and unthreading the nut 24 onto the bolt 22.

In accordance with several features of the present general inventive concept, the header tethering system 10 further includes a tether 16, with a first end 32 of the tether connected to the header clamp 12 and an opposite second end 34 of the tether 16 connected to the collector clamp 14. The tether 16 comprises generally a length of cordage which is sufficiently flexible to allow manipulation of the clamps 12, 14 sufficient to secure the header tethering system 10 to the header 18 and collector 20. In the illustrated embodiment, the tether 16 is fabricated from a length of wire cable. However, it will be recognized that numerous other structures and materials, such as for example rope, chain, elastomeric material, etc., may be used to construct the tether 16 without departing from the spirit and scope of the present general inventive concept. In several embodiments, the tether 16 may be constructed from various materials capable of resisting corrosion after repetitive heat cycles, exposure to weather or the elements, or the like.

In various embodiments, the tether 16 is connected to at least one of the collector clamp 14 and the header clamp 12 via a mechanism that allows for shortening or lengthening the tether 16. Thus, once the clamps 12 are secured to a respective header 18 or collector 20, the length of the tether 16 may be adjusted to reduce slack in the tether 16, and preferably to establish tension between the clamps 12, 14, thereby further securing the header 18 to the collector 20. For example, in the embodiment of FIG. 1, the first end 32 of the tether 16 is secured to a tightening fitting 40, which is in turn secured to a first loop fitting 36. The tightening fitting 40 includes an externally threaded stem 62, and an internally threaded ferrule portion 38 which is adapted to be threadably received onto the stem 62 in order to shorten the length of the tightening fitting 40 along an elongated dimension of the tether 16. Thus, the ferule portion 38 may be threaded onto the stem 62 in order to draw the first loop fitting 36 toward the first end 32 of the tether 16 and may be threadably retreated along the stem 62 in order to separate the first loop fitting 36 from the first end 32 of the tether 16, thereby allowing adjustability of the effective length of the tether 16 between the first loop fitting 36 and the tether second end 34.

In the illustrated embodiment, the opposite second end 34 of the tether 16 is secured to a second loop fitting 42. Each of the respective first and second loop fittings 36, 42 is adapted to receive and encircle a respective shaft portion 56 of the bolt 52 of a respective clamp 12, 14, thereby securing the respective loop fitting 36, 42 to its respective clamp 12, 14. In the illustrated embodiment, the first loop fitting 36 receives the shaft portion 56 of the header clamp 12 therethrough, thereby securing the first loop fitting 36, and the associated tether first end 32, to the header clamp 12 between the loops 28, 30 of the header clamp 12. The second loop fitting 42 receives the shaft portion 56 of the collector clamp 14 therethrough, thereby securing the second loop fitting 42, and the associated tether second end 34, to the collector clamp 14 between the loops 28, 30 of the collector clamp 14. However, it will be recognized that the orientation of the tether 16 may be reversed, i.e., the first loop fitting 36 may be secured to the collector clamp 14 and the second loop fitting 42 may be secured to the header clamp 12, without departing from the spirit and scope of the present general inventive concept.

With reference to FIG. 2, with the first and second loop fittings 36, 42 held along respective bolt shaft portions 56 of respective clamps 12, 14, between respective first and second loops 28, 30 of the clamps 12, 14, each of the clamps 12, 14 may be positioned along a respective header 18 or collector 20 so as to establish full, or substantially full, extension of the tether 16. As shown in FIG. 2, in a preferred configuration, each of the clamps 12, 14, is positioned along a respective header 18 and collector 20 with the bolt 52 of each clamp 12, 14 oriented inward of the bend of the header 18, so as to extend the tether 16 interior of the bend of the header 18 substantially perpendicular to long dimensions of each of the shaft portions 56 of the respective bolts 52. In this configuration, each clamp 12, 14 may be secured to a respective header 18 or collector 20 with the tether 16 extending substantially therebetween, inward of the bend of the header 18. If necessary, the tightening fitting 40 may be tightened in order to reduce any slack present in the tether 16 and/or to establish tension in the tether 16 between the clamps 12, 14. Thus, the header tethering system 10 may provide retention of the collector 20 to the header 18.

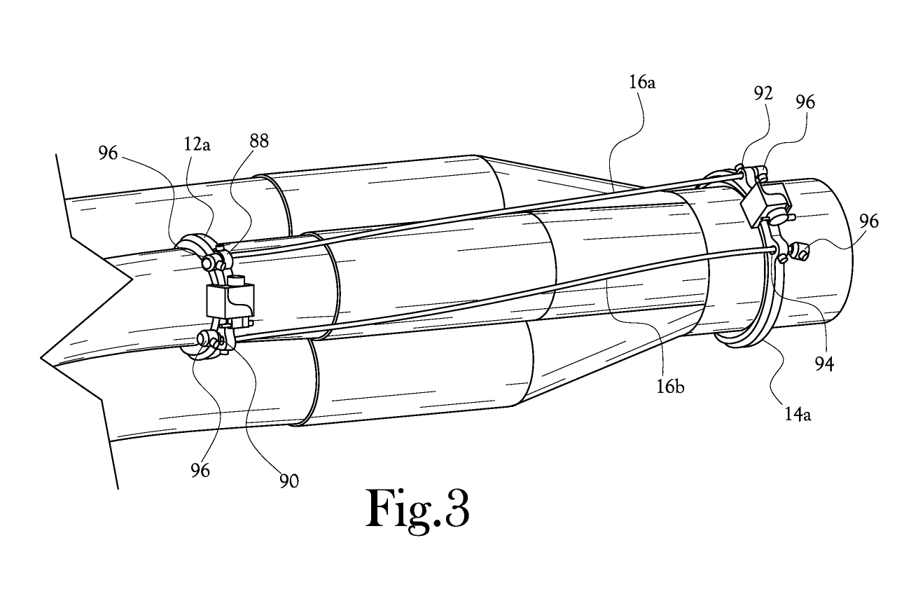

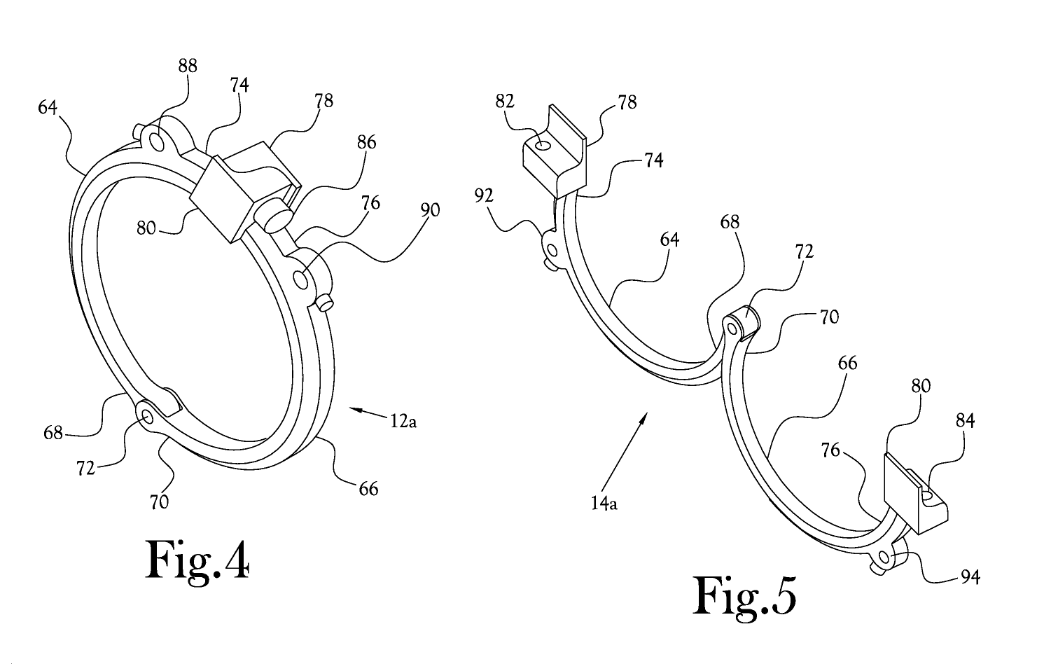

FIGS. 3-5 illustrate another embodiment of a header tethering system 10a. In the embodiment of FIGS. 3-5, each clamp 12a, 14a comprises first and second semicircular rigid members 64, 66 which are rotatably secured at respective first ends 68, 70 thereof via a hinge connection 72. Opposite second ends 74, 76 of the rigid members 64, 66 cooperate to define a pair of matable shapes which are adapted to be mated together to close the respective clamp 12a, 14a with the rigid members 64, 66 in a substantially circular arrangement. For example, in the illustrated embodiment, the second end 74 of the first rigid member 64 defines a first portion 78 of a block, and the second end 76 of the second rigid member 66 defines a second portion 80 of the block. The first and second block portions 78, 80 define matable interior surfaces, such that when the rigid members 64, 66 are rotated toward one another about the hinge 72, the first and second block portions 78, 80 are mated together to complete the block. In various embodiments, a fastener is provided to secure the matable shapes in mating relationship with one another. For example, in the illustrated embodiment, each of the first and second block portions 78, 80 defines a through opening 82, 84. Each through opening 82, 84 is positioned along its respective first or second block portion 78, 80 such that, when the first and second block portions 78, 80 are mated together, the through openings 82, 84 are aligned in substantially coaxial orientation to one another. A fastener 86, such as a screw, nut and bolt assembly, or the like, is receivable within the through openings 82, 84, thereby securing the respective clamp 12a, 14a in a closed position.

In the embodiment of FIGS. 3-5, a plurality of tethers 16a, 16b are provided extending between the respective clamps 12a, 14a. More specifically, in the illustrated embodiment, the header clamp 12a defines first and second tethering points 88, 90 on each of opposite sides of the first and second block portions 78, 80 of the header clamp 12a. Likewise, the collector clamp 14a defines first and second tethering points 92, 94 on each of opposite sides of the first and second block portions 78, 80 of the collector clamp 14a. Each of the tethering points 88, 90, 92, 94 is defined by a through opening extending parallel to a central axis of the respective clamp 12a, 14a. A first tether 16a is secured between the first and third tethering points 88, 92 defined along the header clamp 12 and the collector clamp 14, respectively, and a second tether 16b is secured between the second and fourth tethering points 90, 94 defined along the header clamp 12 and the collector clamp 14, respectively. Each tethering point 88, 90, 92, 94 is disposed along its respective clamp 12a, 14a such that the first and second tethers 16a, 16b extend generally parallel to one another. However, it will be recognized that such parallel configuration of the tethers 16a, 16b is not necessary to the present general inventive concept.

In the illustrated embodiment, a plurality of adjustable stops 96 are provided, with one stop 96 being disposed at each end of each tether 16a, 16b. Each stop 96 is slidably received onto a respective end of each tether 16a, 16b, and is releasably fixable in relation to the respective tether 16a, 16b. Thus, each end of each tether 16a, 16b is received through a respective one of the tethering points 88, 90, 92, 94, and a stop 96 is slidably received onto, and fixed to, each end of each tether 16a, 16b. Each stop 96 is of a sufficiently large sized as to prohibit receipt of the stop 96 through a respective tethering point 88, 90, 92, 94. Thus, the stops 96 serve to retain each end of each tether 16a, 16b through a respective one of the tethering points 88, 90, 92, 94.

In the present embodiment, each clamp 12a, 14a may be positioned along a respective header 18 or collector 20 as discussed above, and thereafter may be closed to lock the clamp 12a, 14a in relation to the respective header 18 or collector 20. Thereafter, one or more of the stops 96 may be slidably adjusted along its respective tether 16a, 16b in order to reduce any slack present in the tethers 16a, 16b and/or to establish tension in the tethers 16a, 16b between the clamps 12a, 14a. In other applications, the header tethering system may be secured to a header 18 and collector 20 such that slack is present in the one or more tethers, thereby allowing for expansion or contraction of the header tethering system or of the header 18 or collector 20 due to thermal effects on these components.

From the foregoing description, it will be recognized that a header tethering system is provided which allows for retention of a collector in relation to a header assembly. It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment. Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

Having thus described the aforementioned invention, what is claimed is:

1. A header tethering device for securing a collector to a header in a header assembly and exhaust system of a motor vehicle, the header tethering device comprising:
a header clamp having a first band configured to encircle the header and establish a frictional connection therewith;
a collector clamp having a second band configured to encircle the collector and establish a frictional connection therewith; and
a flexible tether having a first end mounted to the header clamp and an opposite second end mounted to the collector clamp;
whereby when said header clamp is secured to the header and said collector clamp is secured to the collector with said tether extended therebetween, said tether prevents separation of the header from the collector.

2. The header tethering device of claim 1, each said first and second band being fabricated from a flexible sheet of material.

3. The header tethering device of claim 1, said header clamp and said collector clamp each having an adjustable fastener for urging opposite first and second ends of said respective band toward one another.

4. The header tethering device of claim 3, each said adjustable fastener comprising a nut and bolt assembly.

5. The header tethering device of claim 4, each said first and second end of said first and second bands forming a loop, each said loop having a portion of said adjustable fastener received therein.

6. The header tethering device of claim 5, each said loop having a cutout extending along a circumference of said loop at a central location along an axial dimension of said loop.

7. The header tethering device of claim 6, each said adjustable fastener comprising a bolt, each said bolt having a T-shaped head portion received within a respective band first end loop and an externally-threaded shaft portion extending through said cutouts of said respective band first end and band second end loops.

8. The header tethering device of claim 7, each said adjustable fastener further comprising a tubular insert received within a respective band second end loop, each said tubular insert defining a through opening extending perpendicular to an axial dimension of said insert, each said bolt shaft portion being slidably received through a respective tubular insert through opening.

9. The header tethering device of claim 8, each said adjustable fastener further comprising an internally-threaded nut received along said bolt shaft portion opposite said tubular insert from said head portion, said nut securing said respective tubular insert along said respective bolt shaft portion.

10. The header tethering device of claim 9, each said adjustable fastener further comprising a spacer interposed between said tubular insert and said nut.

11. The header tethering device of claim 10, said tether having opposite first and second ends, each said tether first and second end being secured to a respective one of said bolt shaft portions between said respective band first and second end loops.

12. The header tethering device of claim 11, said tether first end being secured in relation to a first loop fitting encircling said bolt shaft portion of said header clamp.

13. The header tethering device of claim 12, said tether second end being secured to a second loop fitting encircling said bolt shaft portion of said collector clamp.

14. The header tethering device of claim 13 further comprising a fitting interposed between said tether first end and said first loop fitting, said fitting being adjustable to reposition said first loop fitting toward and away from said tether first end.
